(19) United States
(12) Patent Application Publication
(10) Pub. No.: US 2026/0012071 A1
(43) Pub. Date: Jan. 8, 2026

(54) STEPPING MOTOR

(71) Applicant: AAC Microtech (Changzhou) Co., Ltd., Changzhou City (CN)

(72) Inventor: Zhuming Chu, Changzhou (CN)

(21) Appl. No.: 18/988,933

(22) Filed: Dec. 20, 2024

Related U.S. Application Data
(63) Continuation of application No. PCT/CN2024/103167, filed on Jul. 2, 2024.

(51) Int. Cl. H02K 37/14; H02K 1/14; H02K 1/2706; H02K 5/16

(52) U.S. Cl. CPC H02K 37/14; H02K 1/14; H02K 1/2706; H02K 5/161

(57) ABSTRACT

The present disclosure provides a stepping motor, which includes a first cover plate, a second cover plate, and a stator and a rotor sandwiched between the first cover plate and the second cover plate. The rotor includes a shaft and a rotor magnetic steel assembly sleeved and fixed on the shaft. The rotor magnetic steel assembly includes a first rotor magnetic steel assembly and a second rotor magnetic steel assembly spaced from each other. The first rotor magnetic steel assembly and the second rotor magnetic steel assembly respectively include a rotor magnetic ring in a ring shape sleeved and fixed on the shaft and a rotor magnetic steel sleeved and fixed on an outer periphery of the rotor magnetic ring. The stator includes a first driving unit and a second driving unit respectively. Compared with the related art, the present disclosure reduces the torque fluctuation of the stepping motor.

### CROSS-REFERENCE TO RELATED APPLICATIONS

This application is a continuation of International Application No. PCT/CN2024/103167, filed on Jul. 2, 2024, the entire content of which is incorporated herein by reference.

### TECHNICAL FIELD

The present disclosure relates to the technical field of electric motors, and in particular to a stepping motor.

### BACKGROUND

Owing to its compact structure, high power density, high working efficiency, and remarkable energy-saving and consumption-reducing benefits, stepping motors have been widely applied in various fields such as electric motors and generators. In recent years, the industrial sector has an increasingly urgent demand for equipment that utilizes stepping motors to directly driving loads. The extensive application of these stepping motor direct-driving devices will generate immeasurable energy-saving benefits.

A stepping motor generally includes a rotor and a stator. In claw-pole stepping motors, mutually cooperating claw-poles are arranged on the rotor. By setting the polarities of different claw-poles, the torque of the rotor can be enhanced. However, in claw-pole stepping motors of related technologies, the magnetic flux density of the claw-poles tends to be rather saturated due to the torque requirements, resulting in relatively large torque fluctuations of the stepping motor and thus affecting the actual motor performance.

Therefore, it is necessary to provide a new type of stepping motor to ameliorate the above-mentioned problems.

### SUMMARY

The technical problem to be solved by the present disclosure is to provide a stepping motor with smaller torque fluctuation.

In order to solve the above technical problem, the present disclosure provides a stepping motor. The stepping motor includes a first cover plate, a second cover plate, a stator and a rotor sandwiched between the first cover plate and the second cover plate. The stator surrounds the rotor and is spaced from the rotor, the stator is provided with a plurality of claw-poles extending along an axial direction of the rotor. The rotor is supported on the first cover plate and the second cover plate and forms rotational connections with the first cover plate and the second cover plate. The rotor includes a shaft and a rotor magnetic steel assembly sleeved and fixed on the shaft. The rotor magnetic steel assembly includes a first rotor magnetic steel assembly and a second rotor magnetic steel assembly spaced along an axial direction of the shaft, and the first rotor magnetic steel assembly includes a first rotor magnetic ring in a ring shape sleeved and fixed on the shaft and a first rotor magnetic steel sleeved and fixed on an outer periphery of the first rotor magnetic ring. The second rotor magnetic steel assembly includes a second rotor magnetic ring in a ring shape sleeved and fixed on the shaft and a second rotor magnetic steel sleeved and fixed on an outer periphery of the second rotor magnetic ring. The stator includes a first driving unit and a second driving unit distributed along the axial direction of the rotor, the first driving unit is fixed on the first cover plate and surrounds the first rotor magnetic steel, and the second driving unit is fixed on the second cover plate and surrounds the second rotor magnetic steel.

Preferably, the rotor magnetic steel assembly further includes a spacer ring sleeved and fixed on the shaft and located between the first rotor magnetic steel assembly and the second rotor magnetic steel assembly.

Preferably, an outer diameter of the first rotor magnetic ring is the same as an outer diameter of the second rotor magnetic ring, an outer diameter of the spacer ring is less than the outer diameter of the first rotor magnetic ring, and inner diameters of the first rotor magnetic ring, the second rotor magnetic ring and the spacer ring are the same.

Preferably, inner diameters of the first rotor magnetic steel and the second rotor magnetic steel are the same, and outer diameters of the first rotor magnetic steel and the second rotor magnetic steel are the same.

Preferably, radial lengths of the first rotor magnetic steel and the second rotor magnetic steel are the same as radial lengths of the first rotor magnetic ring and the second rotor magnetic ring.

Preferably, each of two ends of the shaft respectively penetrates through the first cover plate and the second cover plate, and respectively forms a rotational connection with the first cover plate and the second cover plate.

Preferably, the stepping motor further includes a first bearing and a second bearing, a groove is respectively arranged at the rotational connections of the first cover plate with the shaft and the second cover plate with the shaft, an outer peripheral side of the first bearing is fixed at the groove of the first cover plate, and an outer peripheral side of the second bearing is fixed at the groove of the second cover plate; each of two ends of the shaft is respectively inserted and fixed on an inner peripheral side of the first bearing and an inner peripheral side of the second bearing.

Preferably, the stator includes a plurality of claw-shaped half bodies, and the claw-shaped half body is provided with a plurality of claw-poles.

Preferably, the first driving unit includes a first cylindrical skeleton, a first coil and a first stator magnetic ring, the first stator magnetic ring is sleeved on the rotor and fixedly connected to the first cover plate, the first stator magnetic ring includes a first claw-shaped half body and a second claw-shaped half body, the first claw-shaped half body and the second claw-shaped half body are opposite to each other and form a first cylindrical accommodating space, the first cylindrical skeleton is fixed inside the first accommodating space, and the first coil is wound around an outer periphery of the first cylindrical skeleton.

Preferably, the second driving unit includes a second cylindrical skeleton, a second coil and a second stator magnetic ring, the second stator magnetic ring is sleeved on the rotor and fixedly connected to the second cover plate, the second stator magnetic ring includes a third claw-shaped half body and a fourth claw-shaped half body, the third claw-shaped half body and the fourth claw-shaped half body are opposite to each other and form a second cylindrical accommodating space, the second cylindrical skeleton is fixed inside the second accommodating space, and the second coil is wound around an outer periphery of the second cylindrical skeleton.

Compared with the related art, the stepping motor of the present disclosure includes a first cover plate, a second cover plate, a stator and a rotor sandwiched between the first cover plate and the second cover plate, the stator surrounds the rotor and is spaced from the rotor, the stator is provided with a plurality of claw-poles extending along an axial direction of the rotor, the rotor is supported on the first cover plate and the second cover plate and forms rotational connections with the first cover plate and the second cover plate, the stator is spaced around the rotor; the rotor includes a shaft which is supported on the first cover plate and the second cover plate and forms rotational connections with the first cover plate and the second cover plate, and a rotor magnetic steel assembly which is sleeved and fixed on the shaft; the rotor magnetic steel assembly includes a first rotor magnetic steel assembly and a second rotor magnetic steel assembly spaced along an axial direction of the shaft, and the first rotor magnetic steel assembly includes a first rotor magnetic ring in a ring shape sleeved and fixed on the shaft and a first rotor magnetic steel sleeved and fixed on an outer periphery of the first rotor magnetic ring; the second rotor magnetic steel assembly includes a second rotor magnetic ring in a ring shape sleeved and fixed on the shaft and a second rotor magnetic steel sleeved and fixed on an outer periphery of the second rotor magnetic ring; the stator includes a first driving unit and a second driving unit distributed along the axial direction of the rotor, the first driving unit is fixed on the first cover plate and surrounds the first rotor magnetic steel, and the second driving unit is fixed on the second cover plate and surrounds the second rotor magnetic steel. In the above structure, the rotor magnetic steels adopt a segmented structure. Different rotor magnetic steels correspond to different driving units respectively. Compared with the scheme using a single rotor magnetic steel, this segmented structure reduces the volume, thereby decreasing the torque fluctuation of the rotor in the stepping motor. Meanwhile, this segmented rotor magnetic steel structure can also reduce the rotational inertia of the rotor as well as the cogging torque, improve the motor's response speed, pull-in torque, and output torque, and reduce the noise during the motor's operation.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

FIG. 1 is a schematic diagram of a 3D structure of a stepping motor according to an embodiment of the present disclosure;

FIG. 2 is a cross-sectional view cut along A-A line of FIG. 1; and

FIG. 3 is a schematic exploded view of the 3D structure of the stepping motor according to the embodiment of the present disclosure.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the described embodiments are only a part of the embodiments of the present disclosure, rather than all the embodiments. Based on the embodiments in the present disclosure, all other embodiments obtained by those ordinarily skilled in the art without doing creative work shall fall within the protection scope of the present disclosure.

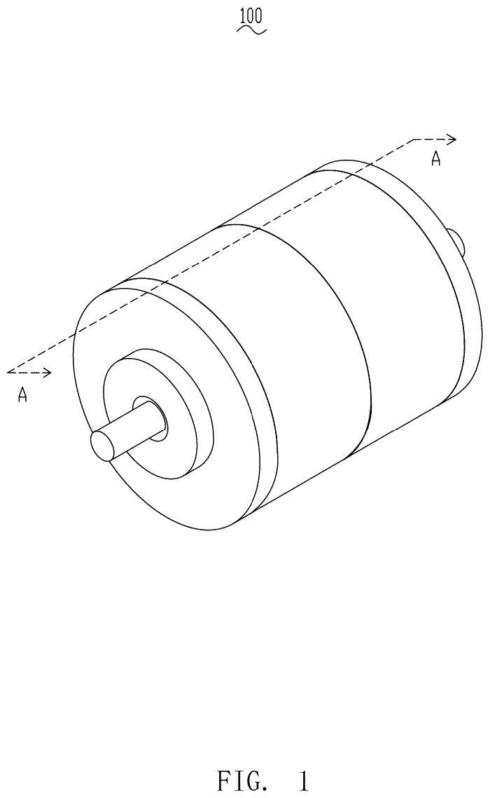

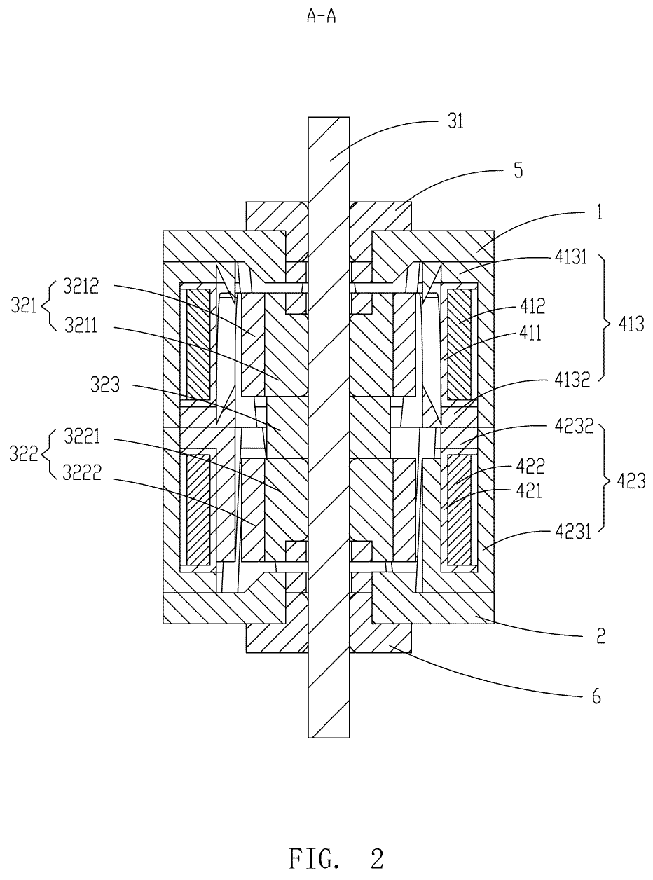

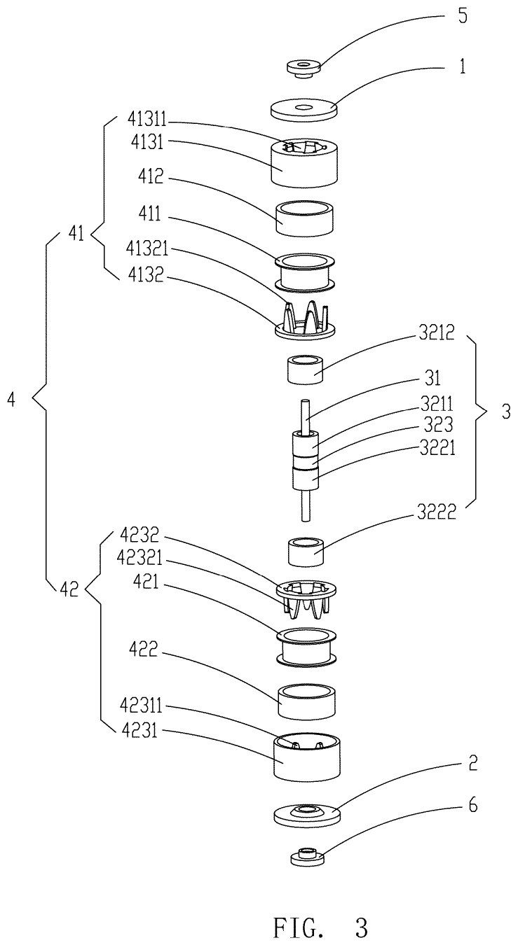

Referring to FIG. 1 to FIG. 3, an embodiment of the present disclosure provides a stepping motor 100. The stepping motor 100 includes a first cover plate 1, a second cover plate 2, a stator 4 and a rotor 3 sandwiched between the first cover plate 1 and the second cover plate 2, the stator 4 surrounds the rotor 3 and is spaced from the rotor 3, the stator 4 is provided with a plurality of claw-poles extending along an axial direction of the rotor 3, and the rotor 3 is supported on the first cover plate 1 and the second cover plate 2 and forms rotational connections with the first cover plate 1 and the second cover plate 2.

The rotor 3 includes a shaft 31 and a rotor magnetic steel assembly 32 sleeved and fixed on the shaft 31.

The rotor magnetic steel assembly 32 includes a first rotor magnetic steel assembly 321 and a second rotor magnetic steel assembly 322 spaced along an axial direction of the shaft 31, and the first rotor magnetic steel assembly 321 includes a first rotor magnetic ring 3211 in a ring shape sleeved and fixed on the shaft 31 and a first rotor magnetic steel 3212 sleeved and fixed on an outer periphery of the first rotor magnetic ring 3211; the second rotor magnetic steel assembly 322 includes a second rotor magnetic ring 3221 in a ring shape sleeved and fixed on the shaft 31 and a second rotor magnetic steel 3222 sleeved and fixed on an outer periphery of the second rotor magnetic ring 3221.

The stator 4 includes a first driving unit 41 and a second driving unit 42 distributed along the axial direction of the rotor 3, the first driving unit 41 is fixed on the first cover plate 1 and surrounds the first rotor magnetic steel 3212, and the second driving unit 42 is fixed on the second cover plate 2 and surrounds the second rotor magnetic steel 3222.

Through this arrangement, an overall structure of the rotor magnetic steel assembly 32 corresponds to the driving units of the stator part. There are no connection parts where different driving units cannot be corresponded during the structural arranging of a single rotor magnetic steel assembly, which can reduce the rotational torque of the rotor.

The rotor magnetic steel assembly 32 further includes a spacer ring 323 sleeved and fixed on the shaft 31 and located between the first rotor magnetic steel assembly 321 and the second rotor magnetic steel assembly 322.

An outer diameter of the first rotor magnetic ring 3211 is the same as an outer diameter of the second rotor magnetic ring 3221, an outer diameter of the spacer ring 323 is less than the outer diameter of the first rotor magnetic ring 3211, and inner diameters of the first rotor magnetic ring 3211, the second rotor magnetic ring 3221 and the spacer ring 323 are the same. With the arrangement of the same inner diameter, the shaft 31 can be attached to the magnetic ring and the spacer ring, ensuring the connection effect.

Inner diameters of the first rotor magnetic steel 3212 and the second rotor magnetic steel 3222 are the same, and outer diameters of the first rotor magnetic steel 3212 and the second rotor magnetic steel 3222 are the same.

Radial lengths of the first rotor magnetic steel 3212 and the second rotor magnetic steel 3222 are the same as radial lengths of the first rotor magnetic ring 3211 and the second rotor magnetic ring 3221. The rotor magnetic steel with the same radial length and outer diameter can ensure the stability of the rotor during rotation and the performance of the motor.

The first rotor magnetic ring 3211 and the second rotor magnetic ring 3221 are made of a magnetic conductive material.

The first rotor magnetic steel 3212 and the first rotor magnetic ring 3211, and the second rotor magnetic steel 3222 and the second rotor magnetic ring 3221 are connected and fixed by glue or snap-fit connection.

Each of two ends of the shaft 31 respectively penetrates through the first cover plate 1 and the second cover plate 2, and respectively forms a rotational connection with the first cover plate 1 and the second cover plate 2.

The stepping motor 100 further includes a first bearing 5 and a second bearing 6, a groove is respectively arranged at the rotational connections of the first cover plate 1 with the shaft 31 and the second cover plate 2 with the shaft 31, an outer peripheral side of the first bearing 5 is fixed at the groove of the first cover plate 1, and an outer peripheral side of the second bearing 6 is fixed at the groove of the second cover plate 2; each of two ends of the shaft 31 is respectively inserted and fixed on an inner peripheral side of the first bearing 5 and an inner peripheral side of the second bearing 6.

The stator 4 includes a plurality of claw-shaped half bodies, and the claw-shaped half body is provided with a plurality of claw-poles. The first driving unit 41 includes a first cylindrical skeleton 411, a first coil 412 and a first stator magnetic ring 413, the first stator magnetic ring 413 is sleeved on the rotor 3 and fixedly connected to the first cover plate 1, the first stator magnetic ring 413 includes a first claw-shaped half body 4131 and a second claw-shaped half body 4132, the first claw-shaped half body 4131 and the second claw-shaped half body 4132 are opposite to each other and form a first cylindrical accommodating space, the first cylindrical skeleton 411 is fixed inside the first accommodating space, and the first coil 412 is wound around an outer periphery of the first cylindrical skeleton 411. During the arrangement process, a plurality of first claw-poles 41311 on the first claw-shaped half body 4131 and a plurality of second claw-poles 41321 on the second claw-shaped half body 4132 are arranged in an interleaved and interlocked manner, stabilizing the magnetic field.

The second driving unit 42 includes a second cylindrical skeleton 421, a second coil 422 and a second stator magnetic ring 423, the second stator magnetic ring 423 is sleeved on the rotor 3 and fixedly connected to the second cover plate 2, the second stator magnetic ring 423 includes a third claw-shaped half body 4231 and a fourth claw-shaped half body 4232, the third claw-shaped half body 4231 and the fourth claw-shaped half body 4232 are opposite to each other and form a second cylindrical accommodating space, the second cylindrical skeleton 421 is fixed inside the second accommodating space, and the second coil 422 is wound around an outer periphery of the second cylindrical skeleton 421. During the arrangement process, a plurality of third claw-poles 42311 on the third claw-shaped half body 4231 and a plurality of fourth claw-poles 42321 on the fourth claw-shaped half body 4232 are arranged in an interleaved and interlocked manner, stabilizing the magnetic field.

Compared with the related art, the stepping motor of the present disclosure includes a first cover plate, a second cover plate, a stator and a rotor sandwiched between the first cover plate and the second cover plate, the stator surrounds the rotor and is spaced from the rotor, the stator is provided with a plurality of claw-poles extending along an axial direction of the rotor, the rotor is supported on the first cover plate and the second cover plate and forms rotational connections with the first cover plate and the second cover plate, the stator is spaced around the rotor; the rotor includes a shaft which is supported on the first cover plate and the second cover plate and forms rotational connections with the first cover plate and the second cover plate, and a rotor magnetic steel assembly which is sleeved and fixed on the shaft; the rotor magnetic steel assembly includes a first rotor magnetic steel assembly and a second rotor magnetic steel assembly spaced along an axial direction of the shaft, and the first rotor magnetic steel assembly includes a first rotor magnetic ring in a ring shape sleeved and fixed on the shaft and a first rotor magnetic steel sleeved and fixed on an outer periphery of the first rotor magnetic ring; the second rotor magnetic steel assembly includes a second rotor magnetic ring in a ring shape sleeved and fixed on the shaft and a second rotor magnetic steel sleeved and fixed on an outer periphery of the second rotor magnetic ring; the stator includes a first driving unit and a second driving unit distributed along the axial direction of the rotor, the first driving unit is fixed on the first cover plate and surrounds the first rotor magnetic steel, and the second driving unit is fixed on the second cover plate and surrounds the second rotor magnetic steel. In the above structure, the rotor magnetic steels adopt a segmented structure. Different rotor magnetic steels correspond to different driving units respectively. Compared with the scheme using a single rotor magnetic steel, this segmented structure reduces the volume, thereby decreasing the torque fluctuation of the rotor in the stepping motor. Meanwhile, this segmented rotor magnetic steel structure can also reduce the rotational inertia of the rotor as well as the cogging torque, improve the motor's response speed, pull-in torque, and output torque, and reduce the noise during the motor's operation.

The above is only the preferred embodiments of the present disclosure. It should be noted that those of ordinary skill in the art can further make improvements without departing from the concept of the present disclosure. These improvements shall all fall within the protection scope of the present disclosure.

What is claimed is:

1. A stepping motor comprising:
a first cover plate;
a second cover plate;
a stator and a rotor sandwiched between the first cover plate and the second cover plate,
wherein the stator surrounds the rotor and is spaced from the rotor, the stator is provided with a plurality of claw-poles extending along an axial direction of the rotor, the rotor is supported on the first cover plate and the second cover plate and forms rotational connections with the first cover plate and the second cover plate;
the rotor comprising:
a shaft; and
a rotor magnetic steel assembly sleeved and fixed on the shaft,
wherein the rotor magnetic steel assembly comprises a first rotor magnetic steel assembly and a second rotor magnetic steel assembly spaced along an axial direction of the shaft, and the first rotor magnetic steel assembly comprises a first rotor magnetic ring in a ring shape sleeved and fixed on the shaft and a first rotor magnetic steel sleeved and fixed on an outer periphery of the first rotor magnetic ring; the second rotor magnetic steel assembly comprises a second rotor magnetic ring in a ring shape sleeved and fixed on the shaft and a second rotor magnetic steel sleeved and fixed on an outer periphery of the second rotor magnetic ring;
the stator comprises a first driving unit and a second driving unit distributed along the axial direction of the rotor, the first driving unit is fixed on the first cover plate and surrounds the first rotor magnetic steel, and the second driving unit is fixed on the second cover plate and surrounds the second rotor magnetic steel.

2. The stepping motor according to claim 1, wherein the rotor magnetic steel assembly further comprises a spacer ring sleeved and fixed on the shaft and located between the first rotor magnetic steel assembly and the second rotor magnetic steel assembly.

3. The stepping motor according to claim 2, wherein an outer diameter of the first rotor magnetic ring is the same as an outer diameter of the second rotor magnetic ring, an outer diameter of the spacer ring is less than the outer diameter of the first rotor magnetic ring, and inner diameters of the first rotor magnetic ring, the second rotor magnetic ring and the spacer ring are the same.

4. The stepping motor according to claim 3, wherein inner diameters of the first rotor magnetic steel and the second rotor magnetic steel are the same, and outer diameters of the first rotor magnetic steel and the second rotor magnetic steel are the same.

5. The stepping motor according to claim 3, wherein radial lengths of the first rotor magnetic steel and the second rotor magnetic steel are the same as radial lengths of the first rotor magnetic ring and the second rotor magnetic ring.

6. The stepping motor according to claim 1, wherein each of two ends of the shaft respectively penetrates through the first cover plate and the second cover plate, and respectively forms a rotational connection with the first cover plate and the second cover plate.

7. The stepping motor according to claim 1, wherein the stepping motor further comprises a first bearing and a second bearing, a groove is respectively arranged at the rotational connections of the first cover plate with the shaft and the second cover plate with the shaft, an outer peripheral side of the first bearing is fixed at the groove of the first cover plate, and an outer peripheral side of the second bearing is fixed at the groove of the second cover plate; each of two ends of the shaft is respectively inserted and fixed on an inner peripheral side of the first bearing and an inner peripheral side of the second bearing.

8. The stepping motor according to claim 1, wherein the stator comprises a plurality of claw-shaped half bodies, and the claw-shaped half body is provided with a plurality of claw-poles.

9. The stepping motor according to claim 8, wherein the first driving unit comprises a first cylindrical skeleton, a first coil and a first stator magnetic ring, the first stator magnetic ring is sleeved on the rotor and fixedly connected to the first cover plate, the first stator magnetic ring comprises a first claw-shaped half body and a second claw-shaped half body, the first claw-shaped half body and the second claw-shaped half body are opposite to each other and form a first cylindrical accommodating space, the first cylindrical skeleton is fixed inside the first accommodating space, and the first coil is wound around an outer periphery of the first cylindrical skeleton.

10. The stepping motor according to claim 8, wherein the second driving unit comprises a second cylindrical skeleton, a second coil and a second stator magnetic ring, the second stator magnetic ring is sleeved on the rotor and fixedly connected to the second cover plate, the second stator magnetic ring comprises a third claw-shaped half body and a fourth claw-shaped half body, the third claw-shaped half body and the fourth claw-shaped half body are opposite to each other and form a second cylindrical accommodating space, the second cylindrical skeleton is fixed inside the second accommodating space, and the second coil is wound around an outer periphery of the second cylindrical skeleton.
